(19) United States
(12) Patent Application Publication
(10) Pub. No.: US 2003/0141699 A1
(43) Pub. Date: Jul. 31, 2003

(54) Motorcyclist's trailer hitch cover

(76) Inventor: Darrel Eugene Collins, Portola Hills, CA (US)

Correspondence Address: Judy A. Collins, 19495 Dorado Drive, Portola Hills, CA, 92679, US

(21) Appl. No.: 10/059,947

(22) Filed: Jan. 31, 2002

(51) Int. Cl. B60D 1/00

(52) U.S. Cl. 280/507

(57) ABSTRACT

This invention relates to hitch covers that are high quality, 100% metal that can be easily installed and removed, yet able to be securely locked in place. Even more specifically, the motorcyclist's receiver hitch cover generally includes a permanent faceplate made from a motorcycle timer cover, transmission end cover or other plate that simulates a prefabricated motorcycle accessory. Of course the design on the front most face of the cover is not limited to the skull design, but can include any desired motorcycle cover design including wings, flames or other widely accepted motorcycle symbols.

### CROSS REFERENCE TO RELATED APPLICATIONS

None

### STATEMENT REGARDING FEDERALLY SPONSORED RESEARCH OR DEVELOPMENT

Not applicable.

### REFERENCE TO A MICROFICHE APPENDIX

Not applcable.

### BACKGROUND OF THE INVENTION

Trailer hitches are commonly installed on the back of vehicles; cars, trucks, SUV's and motorcycles, to allow for the insertion of a tow bar, affording the vehicle the ability to tow a trailer carrying a large load, such as a motorcycle, behind the vehicle. Trailer hitches are large and visible behind the vehicle. When the tow bar is not in place, the trailer hitch receiver tube is exposed leaving an open hole that is unattractive.

A trailer hitch cover is used to cover a vehicle's trailer hitch receiver tube when the standard towing device is not installed. There are several reasons for the use of a hitch cover including providing a decorative plate to customize the vehicles visual appearance, protecting the receiver tube from the rusting agents, and providing a safety feature through lighting and reflectors.

This invention applies to the automotive accessory field. There was a need for a 100% metal, high quality, trailer hitch cover for customized trucks, automobiles, SUV's, and motorcycles that artistically appeals to the biker (motorcycle) market.

### BRIEF SUMMARY OF THE INVENTION

The current invention applies to the trailer hitch apparatus for vehicles including automobiles, trucks, SUV's and motorcycles, and more specifically to covers for the trailer hitch receiver tube. In particular, this invention relates to covers that are high quality, 100% metal that can be easily installed and removed, yet able to be securely locked in place. Even more specifically, the motorcyclist's receiver hitch cover generally includes a permanently secured faceplate made from a motorcycle timer cover, transmission end cover or other plate that simulates a prefabricated motorcycle accessory.

### BRIEF DESCRIPTION OF THE SEVERAL VIEWS OF THE DRAWING

FIG. 1 is a perspective side view of a trailer hitch cover showing the assembly pulled apart.

FIG. 2 is a front perspective view thereof;

FIG. 3 is a front view thereof;

FIG. 4 is a rear perspective view thereof;

FIG. 5 is a rear view thereof;

The broken lines showing of the environment is for illustrative purposes only and forms no part of the claimed design. This use of the prefabricated face plate is the unique aspect of this invention.

### DETAILED DESCRIPTION OF THE INVENTION

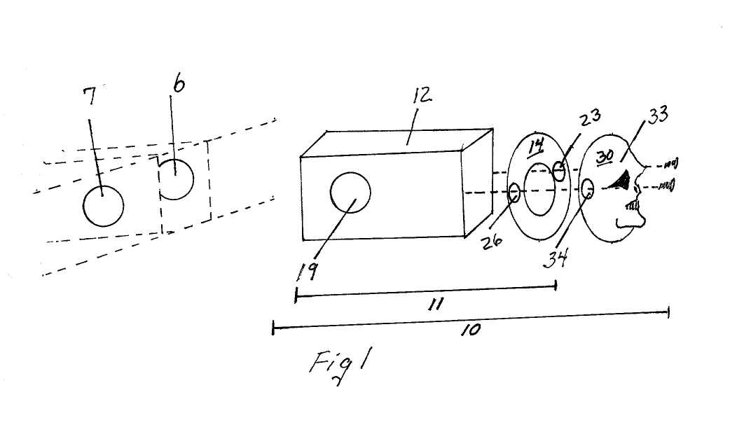

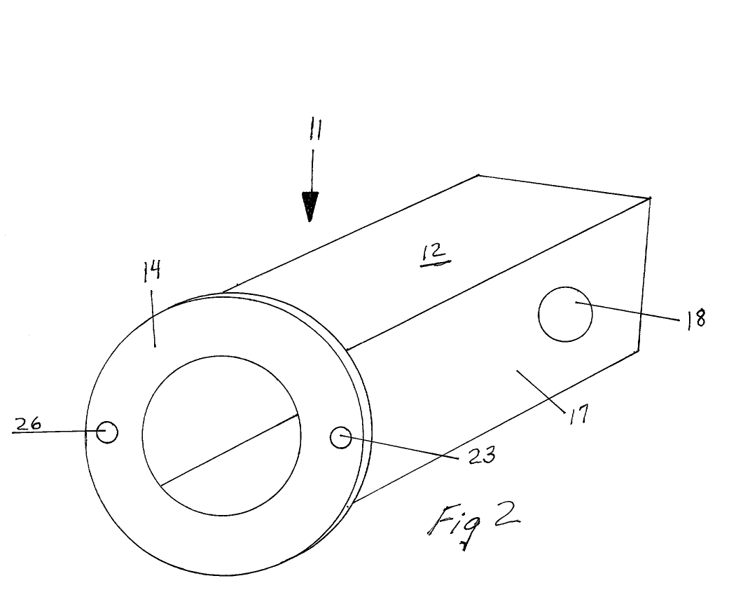

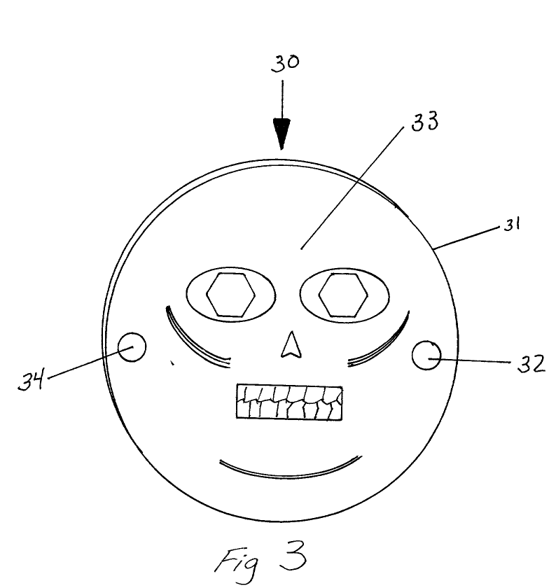

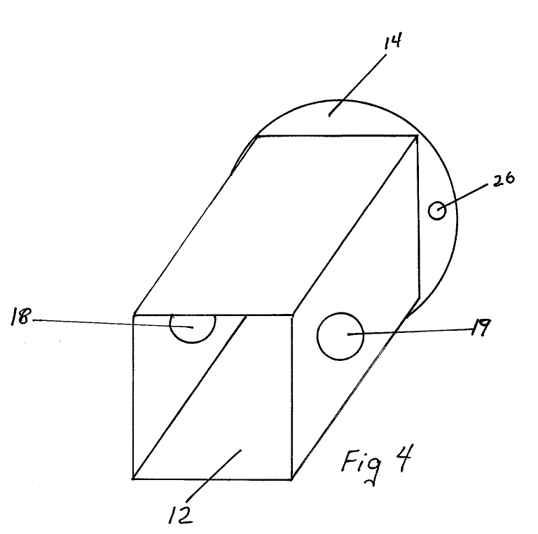

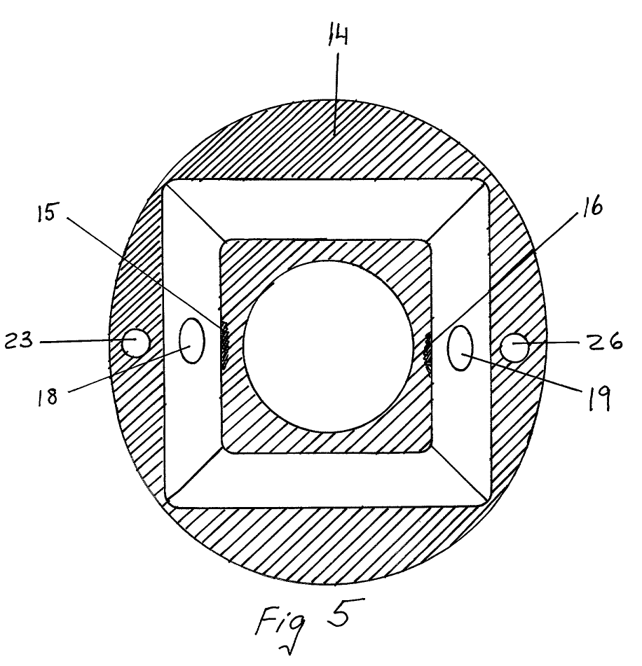

FIGS. 1-5 illustrates one embodiment of a motorcyclist's receiver hitch cover 10 of the current invention. Cover 10 generally includes a faceplate 30 having perifery 31, front face 33 and backside 14. As shown for purposes of illustration, periphery 31 of cover 10 is generally spherical in shape. Of course the design on the front most face of the cover is not limited to the skull design, but can be any desired motorcycle cover design including wings, flames or other widely accepted motorcycle symbols.

This invention embodies the fabrication of a post 11 in order to provide a heavy duty, and lockable means of attaching the hitch cover 10 onto the vehicles trailer hitch 5. This post is constructed of a precut hollow steel bar 12. The bar 12 contains a spherical metal front face washer 14 that is attached to the bar by a first placed inside spot weld joint 15 and a second placed inside spot weld joint 16 that is on the opposing inside edge of the bar and plate connection, an upper horizontal side 17 having a first hitch lock bore 18, which is in alignment with the first retainer-pin bore 6, and a lower horizontal side 13 having a second hitch lock bore 19, which is in alignment with the second retainer-pin bore 7. Additionally, the spherical metal front plate 14 has a first tapped screw hole 23 which may be positioned in alignment with the first hitch lock bore 18, and a second tapped screw hole 26 which may be positioned in alignment with the second hitch lock bore 19. The first tapped screw hole 23, and second tapped screw hole 26 are placed in a position to align correctly with the motorcycle face plate 30. The assembled post 11 is then powder coated to apply a protective, high quality finish.

A cover plate 30, that stimulates a motorcycle accessory, is attached to the prefabricated receiver post 11 by inserting a screw, pretreated with a substance that permanently secures the screw in place into the first screw hole 32 of the cover plate 30 and through the spherical metal front face washer tapped hole 23, and inserting a second screw, pretreated with a substance that permanently secures the screw in place, into the second screw hole 34 of the cover plate and through the washer tapped hole 26.

In order to securely lock the motorcyclist's hitch cover 10 in place, a standard trailer hitch bolt lock that may resemble motorcycle foot pegs 40, is inserted through the outer wall of the receiver plug 6, then the first hitch lock bore 18, then the second hitch lock bore 19, and finally the second outer wall of the receiver plug 7.

What I claim as my invention is:

1) permanently affixing a prefabricated motorcycle timer cover/point cover, transmission end cover, or other customized face plate that stimulates a motorcycle accessory to a steel bar that is designed to removably attach the prefabricated cover plate to the hitch plug: Said bar is:
a) attached at one end to a spherical metal face plate by means of spot welding
b) powder coated to prevent rusting and erosion
c) fitted with two opposing bore holes that allow for the fitting of a standard trailer hitch lock

2) The prefabricated face plate of claim 1 wherein said post and said face plate are attached together by screws and a permanent locking agent

3) The prefabricated face plate of claim 1 wherein said cover design is a 3D skull that may contain cut crystal eyes

4) The prefabricated face plate of claim 1 wherein said cover design is a prefabricated motorcycle timer cover

5) The prefabricated face plate of claim 1 wherein said cover design is a prefabricated motorcycle transmission end cover

6) The prefabricated face plate of claim 1 wherein said cover design is a motorcycle accessory

7) The prefabricated face plate of claim 1 wherein said motorcycle accessory is adapted for use on a vehicles trailer hitch plug.
